(19) United States
(12) Patent Application Publication
(10) Pub. No.: US 2024/0043290 A1
(43) Pub. Date: Feb. 8, 2024

(54) ULTRAVIOLET FLUID STERILIZING BOX STRUCTURE

(71) Applicant: HERGY INTERNATIONAL CORP., Taipei City (TW)

(72) Inventors: Chun-Hung LU, Taipei City (TW); Chia-Te LIN, Taipei City (TW); Chih-Hsin CHEN, Taipei City (TW)

(21) Appl. No.: 17/881,576

(22) Filed: Aug. 4, 2022

(51) Int. Cl. C02F 1/32

(52) U.S. Cl. CPC C02F 1/325; C02F 2201/3228; C02F 2201/3222; C02F 2303/04

(57) ABSTRACT

This disclosure is related to an ultraviolet fluid sterilizing box structure. A box (10) includes a chamber (100), a water inlet (101) and a water outlet (102). The water inlet (101) and the water outlet (102) are located on different sides of the box (10). The partition (20) is disposed in the chamber (100) and includes an outer cylinder (21) and an inner cylinder (22). The outer cylinder (21) includes an outer cavity (210) and an inflow inlet (211). The inner cylinder (22) includes an inner cavity (220) and an opening (221). The ultraviolet module (30) is disposed on one side of the box (10) and includes a light-transmitting plate (31) and an ultraviolet lamp set (32). The light-transmitting plate (31) seals the outer cylinder (21). The ultraviolet rays irradiate the inner cavity (220) and the outer cavity (210).

### BACKGROUND OF THE DISCLOSURE

### Technical Field

The technical field relates to an ultraviolet sterilizing device, and more particularly relates to an ultraviolet fluid sterilizing box structure.

### Description of Related Art

Currently, the devices with ultraviolet (UV) lamps (such as a UV light tube or LED) for sterilizing fluid such as water or air are already in the market. A UV lamp is arranged inside or outside a box and a single flow channel is used to have fluid being irradiated by UV rays. Therefore, sterilization may be accomplished by irradiating the fluid with UV rays for a certain time.

Moreover, in a related-art sterilizing box structure, the flow channel is lengthened to prolong the irradiating time. However, the volume is also increased. Also, the flow channel is flattened to decrease the irradiating distance for better effect of sterilization. However, the flow resistance is increased and the flowrate is reduced.

In view of the above drawbacks, the inventor proposes this disclosure based on his expert knowledge and elaborate researches in order to solve the problems of related art.

### SUMMARY OF THE DISCLOSURE

One object of this disclosure is to provide an ultraviolet fluid sterilizing box structure, in which the fluid in the box may be irradiated by sufficient ultraviolet rays to achieve a better effect of sterilization to increase the utility of this disclosure.

In the embodiment of this disclosure, an ultraviolet fluid sterilizing box structure includes a box, a partition and an ultraviolet module. The box includes a chamber, a water inlet and a water outlet. Both the water inlet and the water outlet communicate with the chamber. The water inlet is located on one side surface of the box, and the water outlet is located on another side surface of the box. The partition is disposed in the chamber and includes an outer cylinder and an inner cylinder. The outer cylinder includes an outer cavity and an inflow inlet communicating with the water inlet. The inner cylinder includes an inner cavity, an opening and a flow outlet. The opening communicates with the outer cavity, and the flow outlet communicates with the water outlet. The ultraviolet module is disposed on a side of the box opposite to the water outlet and includes a light-transmitting plate and an ultraviolet lamp set. The light-transmitting plate is combined on the box and seals a side of the outer cylinder. The ultraviolet lamp set is arranged on the outer side of the light-transmitting plate, and ultraviolet rays emitted from the ultraviolet lamp set irradiate the inner cavity and the outer cavity. An external fluid flows into the chamber from the at least one water inlet, enters the outer cavity via the inflow inlet, flows into the inner cavity via the opening, and finally flows to outside from the water outlet via the flow outlet.

In comparison with the related art, the ultraviolet fluid sterilizing box structure in this disclosure is equipped with the partition inside the box. The partition includes an outer cylinder and an inner cylinder to separate the outer cavity and the inner cavity communicating with each other. Thus, the fluid enters the box flows spirally from the outer cavity of the outer cylinder, and flows into the inner cavity of the inner cylinder and then flows out. Accordingly, the flow path of the fluid inside the box is extended to fully sterilize the fluid by ultraviolet rays to achieve the purpose of disinfection and sterilization. Additionally, the ultraviolet rays emitted by the ultraviolet lamp set in this disclosure may directly irradiate the water outlet communicating with outside to prevent the water outlet from breeding bacterium of long-time contacting the outside air, and the utility of this disclosure is improved

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective schematic view of the ultraviolet fluid sterilizing box structure in this disclosure.

FIG. 2 is a perspective exploded view of the ultraviolet fluid sterilizing box structure in this disclosure.

FIG. 3 is a perspective exploded view of the ultraviolet module and the supporting seat in this disclosure.

FIG. 4 is a fluid flowing schematic view of the ultraviolet fluid sterilizing box structure in this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

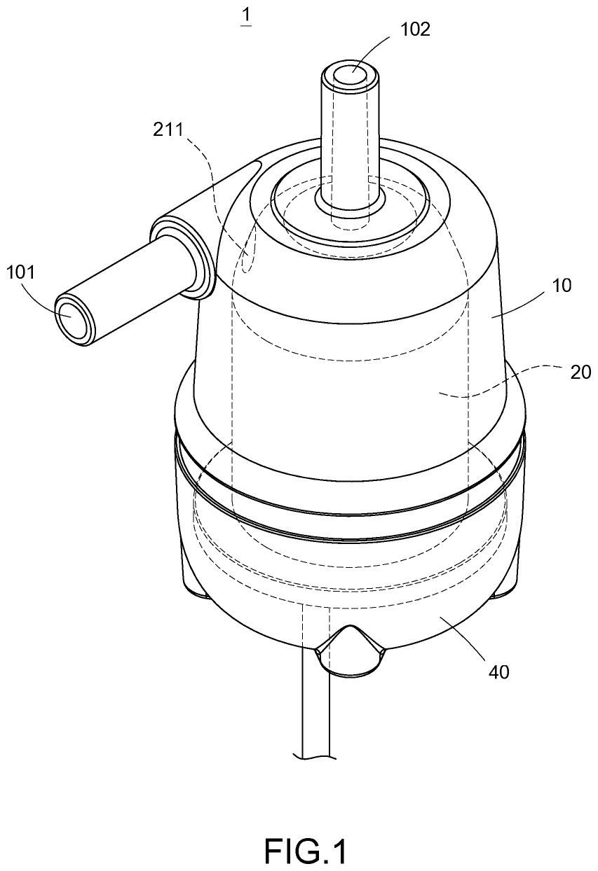

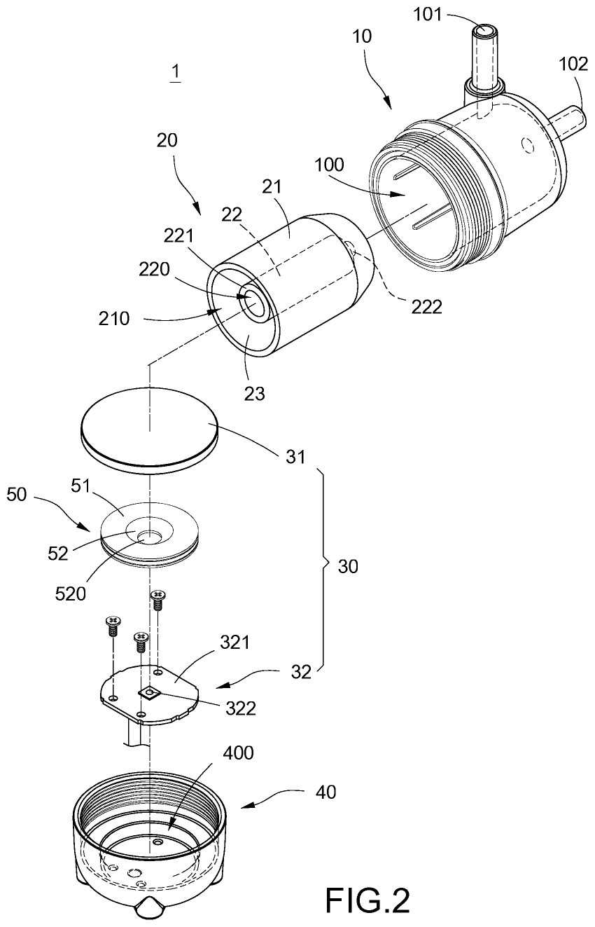

Please refer to FIG. 1 and FIG. 2, which depict a perspective schematic view and a perspective exploded view of the ultraviolet fluid sterilizing box structure in this disclosure. The ultraviolet fluid sterilizing box structure 1 in this disclosure includes a box 10, a partition 20 and an ultraviolet module 30. The partition 20 is disposed in the box 10 to separate the inside of the box 10. The ultraviolet module 30 is disposed in the box 10 to irradiate the fluid in the box 10 to achieve the effect of ultraviolet sterilization for the fluid in the box 10. More detail of the ultraviolet fluid sterilizing box structure 1 is described as below.

The box 10 includes a chamber 100, at least one water inlet 101 and at least one water outlet 102. Both the water inlet 101 and the water outlet 102 are connected (and communicate) with the chamber 100. The water inlet 101 is located on one side surface of the box 10, and the water outlet 102 is located on another side surface of the box 10. Further, the water inlet 101 is located on the side of the box body 10 adjacent to the water outlet 102. In this embodiment, the water outlet 102 is located on the top of the box 10, but it is not limited thereto. The position of the water outlet 102 may be changed according to the demands.

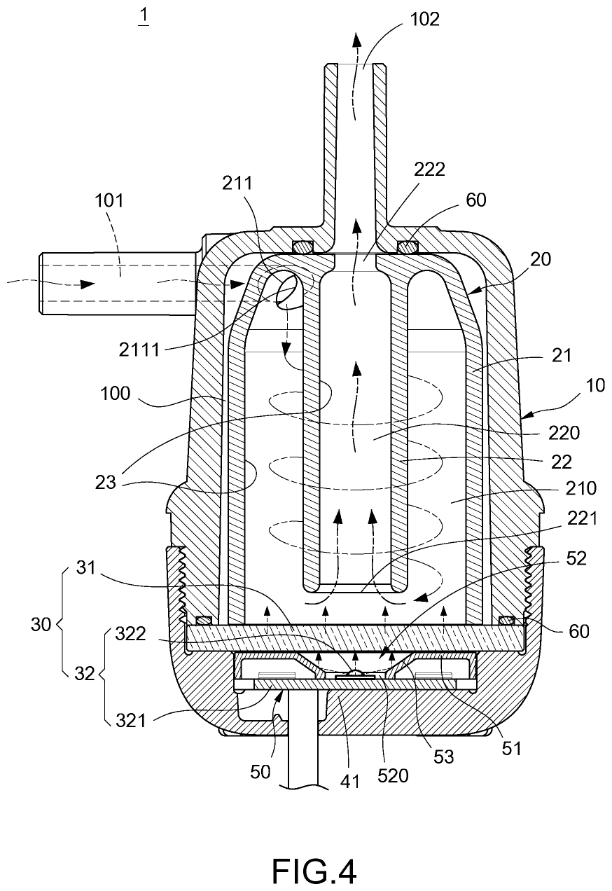

The partition 20 is disposed in the chamber 100. The partition 20 includes an outer cylinder 21 and an inner cylinder 22. The outer cylinder 21 includes an outer cavity 210 and is provided with at least one inflow inlet 211 communicating with the water inlet 101. In one embodiment of this disclosure, the inflow inlet 211 includes a chamfered surface 2111 (refer to FIG. 4). The arrangement of the chamfered surface 2111 facilitates the fluid entering the outer cavity 210 and flowing spirally in the outer cavity 210. Specifically, the partition 10 (including the outer cylinder 21 and the inner cylinder 22) is in a cylindrical shape.

It should be noted that the number of the water inlet 101 and the inflow inlet 211 may be multiple correspondingly to increase the flow rate and the water flow.

Moreover, the inner cylinder 22 includes an inner cavity 220. The inner cylinder 22 is provided with an opening 221 and a flow outlet 222. The opening 221 communicates with the outer cavity 210, and the flow outlet 222 communicates with the water outlet 102.

In some embodiment of this disclosure, inner wall surfaces of the outer cavity 210 and the inner cavity 220 are provided with a reflective layer 23 respectively. The reflective layer 23 is arranged to reflect ultraviolet rays irradiating on the inner wall surface, so as to increase the effect of ultraviolet sterilization.

Furthermore, the ultraviolet module 30 is disposed on one side of the box 10 opposite to the water outlet 102. The ultraviolet module 30 includes a light-transmitting plate 31 and an ultraviolet lamp set 32. The light-transmitting plate 31 is combined on the box 10 and seals one side of the outer cylinder 21. The ultraviolet lamp set 32 includes a circuit board 321 and at least one ultraviolet LED 322. Additionally, the ultraviolet lamp set 32 is disposed on the outer side of the light-transmitting plate 31, and the ultraviolet rays emitted from the ultraviolet lamp set 32 irradiate the inner cavity 220 and the outer cavity 210.

In one embodiment of this disclosure, the ultraviolet fluid sterilizing box structure 1 further includes a heat dissipation seat 40. The heat dissipation seat 40 is combined with the box 10 and supports the ultraviolet module 30. In more detail, the heat dissipation seat 40 includes an accommodating space 400 and a heat-conducting block 41 formed in the accommodating space 400 (refer to FIG. 4), and the ultraviolet lamp set 32 is attached to the heat-conducting block 41. Further, the heat dissipation seat 4 is a metal base made of a material with desirable thermal conductivity. Additionally, the heat dissipation seat 40 is connected to the box 10 by screwing.

Accordingly, the heat generated by the ultraviolet lamp set 32 is conducted to the heat-conducting block 41, and then transferred to the heat dissipation seat 40 through the heat-conducting block 41. The heat of the ultraviolet lamp set 32 may be dissipated through the heat dissipation seat 40 to achieve the purpose of heat dissipation.

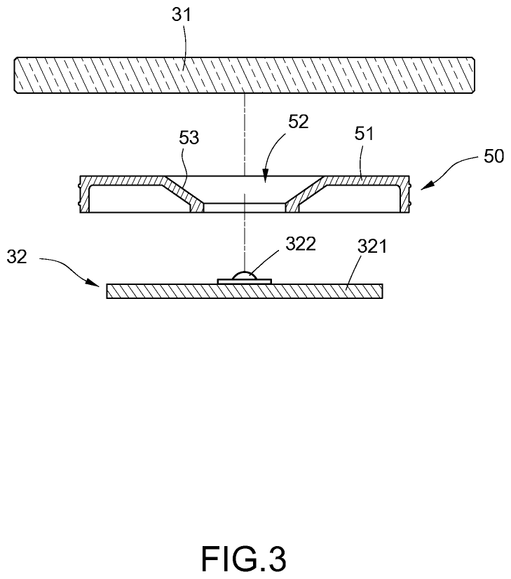

Please further refer to FIG. 3, which depicts a perspective exploded view of the ultraviolet module and the supporting seat in this disclosure. In this embodiment, the ultraviolet fluid sterilizing box structure 1 further includes a supporting seat 50. The supporting seat 50 is disposed between the light-transmitting plate 31 and the ultraviolet lamp set 32. Specifically, the supporting seat 50 includes a platform 51 and a slot 52. The platform 51 abuts against one side of the light-transmitting plate 31. The slot 52 is provided with a notch 520, and the ultraviolet LED 322 is exposed from the notch 520.

It should be noted that the platform 51 of the supporting seat 50 is provided to support the fluid pressure inside the box 10, so as to disperse the pressure of the fluid exerting on the light-transmitting plate 31 and to prevent the light-transmitting plate 31 from being deformed. Furthermore, a reflective layer 23 is disposed on the inner wall of the slot 52. The reflective layer 53 is arranged to reflect the ultraviolet rays irradiating on the inner wall of the slot 52 to increase the effect of ultraviolet sterilization. Additionally, in some embodiment, the number of the ultraviolet LED 322 may be multiple. The arrangement of the slot 52 of the supporting seat 50 may be changed according to the positions of the ultraviolet LEDs 322.

Please further refer to FIG. 4, which depicts a fluid flowing schematic view of the ultraviolet fluid sterilizing box structure in this disclosure. As shown in the figure, when the ultraviolet fluid sterilization box in this disclosure is in use, an external fluid flows into the chamber 100 from the water inlet 101, and enters the outer cavity 210 via the inflow inlet 211. Then, the external fluid is pushed by the fluid behind and its own weight to flow spirally in the outer cavity 210. Next, the fluid enters the inner cavity 220 via the opening 221 of the inner cylinder 22. Additionally, the fluid staying in the inner cavity 220 may be pushed by the fluid behind to move upward, and flows to outside from the water outlet 102 via the flow outlet 222.

It is worth noticing that the ultraviolet rays emitted from the ultraviolet lamp set 32 irradiate the fluid in the inner cavity 220 and the outer cavity 210. The fluid flows spirally in the outer cavity 210, and then enters the inner cavity 220 of the inner cylinder 22, so as to extend the flow path of the fluid inside the box 10. Furthermore, the ultraviolet rays emitted from the ultraviolet lamp set 32 irradiate the inner cavity 220 and the outer cavity 210. Therefore, the ultraviolet sterilization of the fluid is fully performed to achieve the purpose of disinfection and sterilization.

Furthermore, in this embodiment, the ultraviolet LED 322 is disposed corresponding to the location of the water outlet 102. Since the ultraviolet rays emitted from the ultraviolet lamp set 32 may directly irradiate the water outlet 102 connected (communicating) to the outside to prevent the water outlet 102 from breeding bacteria of long-time contacting the outside air.

Moreover, the ultraviolet fluid sterilization box structure 1 further includes a plurality of sealing rings 60. In the embodiment, the sealing rings 60 are disposed between the box 10 and the partition 20, between the box 10 and the light-transmitting plate 31 respectively. The arrangement of the sealing rings 60 may increase the tightness of the ultraviolet fluid sterilization box structure 1 to prevent the fluid inside the box 10 from seeping out or infiltrating the ultraviolet lamp set 32, so as to maintain the normal operation of the ultraviolet fluid sterilization box structure 1.

While this disclosure has been described by means of specific embodiments, numerous modifications and variations could be made thereto by those skilled in the art without departing from the scope and spirit of this disclosure set forth in the claims.

What is claimed is:

1. An ultraviolet fluid sterilizing box structure, comprising:
a box (10), comprising a chamber (100), at least one water inlet (101) and at least one water outlet (102) both communicating with the chamber (100), wherein the at least one water inlet (101) is located on one side surface of the box (10), and the at least one water outlet (102) is located on another side surface of the box (10);
a partition (20), disposed in the chamber (100), comprising an outer cylinder (21) and an inner cylinder (22), wherein the outer cylinder (21) comprises an outer cavity (210) and at least one inflow inlet (211) communicating with the at least one water inlet (101), and the inner cylinder (22) comprises an inner cavity (220), an opening (221) communicating with the outer cavity (210) and a flow outlet (222) communicating with the water outlet (102); and
an ultraviolet module (30), disposed on a side of the box (10) opposite to the water outlet (102), comprising a light-transmitting plate (31) and an ultraviolet lamp set (32), wherein the light-transmitting plate (31) is combined on the box (10) and seals a side of the outer cylinder (21), the ultraviolet lamp set (32) is arranged on an outer side of the light-transmitting plate (31), and an ultraviolet ray emitted from the ultraviolet lamp set (32) irradiates the inner cavity (220) and the outer cavity (210);
wherein, an external fluid flows into the chamber (100) from the at least one water inlet (101), enters the outer cavity (210) via the at least one inflow inlet (211), flows into the inner cavity (220) via the opening (221), and flows to outside from the water outlet (102) via the flow outlet (222).

2. The ultraviolet fluid sterilizing box structure according to claim 1, wherein the partition (20) is in a cylindrical shape, and the at least one water inlet (101) is located on a side of the box (10) adjacent to the water outlet (102).

3. The ultraviolet fluid sterilizing box structure according to claim 1, wherein a reflective layer (23) is respectively disposed on an inner wall surface of the outer cavity (210) and an inner wall surface of the inner cavity (220).

4. The ultraviolet fluid sterilizing box structure according to claim 1, further comprising: a heat dissipation seat (40), combined on the box (10) and supporting the ultraviolet module (30).

5. The ultraviolet fluid sterilizing box structure according to claim 4, wherein the heat dissipation seat (40) comprises an accommodating space (400) and a heat-conducting block (41) disposed in the accommodating space (400), and the ultraviolet lamp set (32) is attached to the heat-conducting block (41).

6. The ultraviolet fluid sterilizing box structure according to claim 1, wherein the ultraviolet lamp set (32) comprises a circuit board (321) and at least one ultraviolet LED (322).

7. The ultraviolet fluid sterilizing box structure according to claim 6, wherein the ultraviolet LED (322) is disposed corresponding to the water outlet (102).

8. The ultraviolet fluid sterilizing box structure according to claim 6, further comprising: a supporting seat (50), disposed between the light-transmitting plate (31) and the ultraviolet lamp set (32).

9. The ultraviolet fluid sterilizing box structure according to claim 8, wherein the supporting seat (50) comprises a platform (51) and a slot (52), the platform (51) abuts against a side surface of the light-transmitting plate (31), a notch (520) is defined on the slot (52), and the ultraviolet LED (322) is exposed from the notch (520).

10. The ultraviolet fluid sterilizing box structure according to claim 9, wherein a reflective layer (23) is disposed on an inner wall of the slot (52).
